(19) United States
(12) Patent Application Publication
(10) Pub. No.: US 2015/0154718 A1
(43) Pub. Date: Jun. 4, 2015

(54) INFORMATION PROCESSING APPARATUS, INFORMATION PROCESSING METHOD, AND COMPUTER-READABLE MEDIUM

(71) Applicant: FUJI XEROX CO., LTD., Tokyo (JP)

(72) Inventors: Toru FUSE, Kanagawa (JP); Masako KITAZAKI, Kanagawa (JP)

(73) Assignee: FUJI XEROX CO., LTD., Tokyo (JP)

(21) Appl. No.: 14/286,205

(22) Filed: May 23, 2014

(30) Foreign Application Priority Data
Dec. 2, 2013 (JP) 2013-249077

(51) Int. Cl. G06Q 50/00; G06F 3/048

(52) U.S. Cl. CPC G06Q 50/01; G06F 3/048

(57) ABSTRACT

An information processing apparatus includes a detection unit, an analysis unit, and a display unit. The detection unit detects pieces of information used in a meeting and operator's operations performed in the meeting or device operations performed in the meeting. The analysis unit analyzes a co-occurrence relationship between the pieces of information and the operator's operations or the device operations which are detected by the detection unit. The display unit displays the relationship between the pieces of information and the operator's operations or the device operations which are detected by the detection unit, on the basis of a result of the analysis performed by the analysis unit.

### CROSS-REFERENCE TO RELATED APPLICATIONS

This application is based on and claims priority under 35 USC 119 from Japanese Patent Application No. 2013-249077 filed Dec. 2, 2013.

### BACKGROUND

### Technical Field

The present invention relates to an information processing apparatus, an information processing method, and a computer-readable medium.

### SUMMARY

The gist of the present invention resides in the following aspect of the invention.

According to an aspect of the invention, there is provided an information processing apparatus including a detection unit, an analysis unit, and a display unit. The detection unit detects pieces of information used in a meeting and operator's operations performed in the meeting or device operations performed in the meeting. The analysis unit analyzes a co-occurrence relationship between the pieces of information and the operator's operations or the device operations which are detected by the detection unit. The display unit displays the relationship between the pieces of information and the operator's operations or the device operations which are detected by the detection unit, on the basis of a result of the analysis performed by the analysis unit.

### BRIEF DESCRIPTION OF THE DRAWINGS

Exemplary embodiment of the present invention will be described in detail based on the following figures, wherein:

FIG. 1 is a schematic diagram illustrating an exemplary module configuration according to an exemplary embodiment;

FIG. 2 is a flowchart of an exemplary process according to the present exemplary embodiment;

FIG. 3 is a diagram for describing a target to be processed, and an exemplary process according to the present exemplary embodiment;

FIG. 4 is a diagram for describing an exemplary data structure of a context-information extraction definition table;

FIG. 5 is a diagram for describing an exemplary data structure of a context-information table;

FIG. 6 is a diagram for describing an exemplary process of an information analysis module;

FIG. 7 is a diagram for describing an exemplary process of the information analysis module;

FIG. 8 is a diagram for describing an exemplary process of the information analysis module;

FIG. 9 is a diagram for describing a target to be processed, and an exemplary process according to the present exemplary embodiment;

FIG. 10 is a diagram for describing an exemplary process according to the present exemplary embodiment;

FIGS. 11A and 11B are diagrams for describing an exemplary process according to the present exemplary embodiment;

FIG. 12 is a diagram for describing an exemplary process according to the present exemplary embodiment;

FIG. 13 is a diagram for describing an exemplary process according to the present exemplary embodiment;

FIG. 14 is a diagram for describing an exemplary process according to the present exemplary embodiment;

FIG. 15 is a diagram for describing an exemplary process according to the present exemplary embodiment;

FIG. 16 is a diagram for describing an exemplary process according to the present exemplary embodiment;

FIG. 17 is a diagram for describing an exemplary process according to the present exemplary embodiment;

FIGS. 18A and 18B are diagrams for describing an exemplary process according to the present exemplary embodiment;

FIG. 19 is a diagram for describing an exemplary process according to the present exemplary embodiment; and

FIG. 20 is a block diagram illustrating an exemplary hardware configuration of a computer for implementing the present exemplary embodiment.

### DETAILED DESCRIPTION

An exemplary embodiment suitable to embody the present invention will be described below on the basis of the drawings.

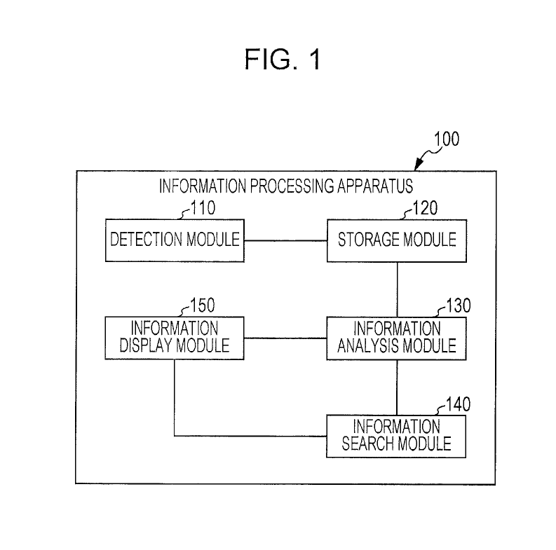

FIG. 1 is a schematic diagram illustrating an exemplary module configuration according to the present exemplary embodiment.

In general, a module refers to a component, such as software that is logically separable (a computer program) or hardware. Thus, a module in the exemplary embodiment refers to not only a module in terms of a computer program but also a module in terms of a hardware configuration. Consequently, the description of the exemplary embodiment serves as the description of a system, a method, and a computer program which cause the hardware configuration to function as a module (a program that causes a computer to execute procedures, a program that causes a computer to function as units, or a program that causes a computer to implement functions). For convenience of explanation, the terms “to store something” and “to cause something to store something”, and equivalent terms are used. These terms mean that a storage apparatus stores something or that a storage apparatus is controlled so as to store something, when computer programs are used in the exemplary embodiment. One module may correspond to one function. However, in the implementation, one module may constitute one program, or multiple modules may constitute one program. Alternatively, multiple programs may constitute one module. Additionally, multiple modules may be executed by one computer, or one module may be executed by multiple computers in a distributed or parallel processing environment. One module may include another module. Hereinafter, the term “connect” refers to logical connection, such as transmission/reception of data, an instruction, or reference relationship between pieces of data, as well as physical connection. The term “predetermined” refers to a state in which determination has been made before a target process. This term also includes a meaning in which determination has been made in accordance with the situation or the state at that time or before that time, not only before processes according to the exemplary embodiment start, but also before the target process starts even after the processes according to the exemplary embodiment have started. When multiple “predetermined values” are present, these may be different from each other, or two or more of the values (including all values, of course) may be the same. A description having a meaning of “when A is satisfied, B is performed” is used as a meaning in which whether or not A is satisfied is determined and, when it is determined that A is satisfied, B is performed. However, this term does not include a case where the determination of whether or not A is satisfied is unnecessary.

A system or an apparatus refers to one in which multiple computers, pieces of hardware, devices, and the like are connected to each other by using a communication unit such as a network which includes one-to-one communication connection, and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (social system) which is constituted by man-made agreements.

In each of the processes corresponding to modules, or in each of the processes included in a module, target information is read out from a storage apparatus. After the process is performed, the processing result is written in a storage apparatus. Accordingly, no description about the reading of data from the storage apparatus before the process and the writing into the storage apparatus after the process may be made. Examples of the storage apparatus may include a hard disk, a random access memory (RAM), an external storage medium, a storage apparatus via a communication line, and a register in a central processing unit (CPU).

Remarks which trigger an animated discussion, or messages or ideas which exert an influence on the overall discussion rather than particulars may be presented in a meeting.

Operators' operations and device operations which promote a flow of discussion or a creative situation that produces such remarks, messages, ideas, and the like and that is produced by participants are referred to as “key contexts”.

Typically, a meeting may be recorded in rich media such as a video and a sound. In the related art, in order to find out a key context from the recorded information, for example, the video needs to be analyzed in detail to analyze the context. Therefore, although a key context plays a major role, it is difficult to objectively and explicitly present a key context, and the key context fails to be reused as knowledge or experience.

An information processing apparatus 100 according to the present exemplary embodiment displays the relationship between information used in a meeting and operators' operations or device operations. As illustrated in FIG. 1, the information processing apparatus 100 includes a detection module 110, a storage module 120, an information analysis module 130, an information search module 140, and an information display module 150.

The detection module 110 is connected to the storage module 120. The detection module 110 detects information used in a meeting, and operators' operations or device operations in the meeting. The detection module 110 captures the information, the operators' operations, and the device operations in the meeting.

In a meeting, people conduct a study, a discussion, and the like, and operations (such as selection, moving, deletion, creation, editing, and viewing) are performed on information. In addition, operators perform operations on the information, or devices are operated to handle the information. Examples of a meeting include what are called a meeting for reviewing an idea, a discussion, a workshop, a conference, a meeting for producing ideas, and a review meeting.

Examples of information (hereinafter, also referred to as content) include an electronic document (hereinafter, also referred to as a document), an electronic sticky note (hereinafter, also referred to as a sticky note), an electronic pasteboard on which electronic sticky notes are attached, an electronic video (including a still image and a movie), an electronic sound, and a combination of these. The detection module 110 detects information which is a target in the meeting, i.e., an information identification (ID) with which the information may be identified in the present exemplary embodiment.

An operator (a participant or a facilitator in a meeting) may be specified, for example, by specifying the owner (the operator ID with which an operator may be identified in the present exemplary embodiment) of a device, such as a personal computer (PC) or a cellular phone (including a smart phone), with which an operation is performed, or by reading an integrated circuit (IC) card or the like carried by the operator to obtain the operator ID. An operation performed by an operator may be detected by using the detection module 110 which detects an operation performed on a device, or by using the detection module 110 which uses a sensor, a camera, or the like to detect an operation performed by the operator. Examples of an operation include writing onto a whiteboard, a stocky note, or the like, editing (specifically, switching of sticky notes, modification or addition of a handwritten annotation written with an electronic pen, and the like), a speech detected by a sensor, raising of a hand, and moving.

A target device may be any device as long as it is used in the meeting. A device operation may be detected in such a manner that the device notifies the detection module 110 of the operation, or that the detection module 110 uses a sensor, a camera, or the like to detect the device operation. Examples of a device include a keyboard, an infrared camera, a digital pen, a whiteboard, a projector, and a printer. Examples of a device operation include power-on and power-off, as well as the functions provided by the device. For example, a function provided by a device may be one of making transition of a screen when a projector is used, and may be one of making transition of a screen (scrolling) when a whiteboard is used.

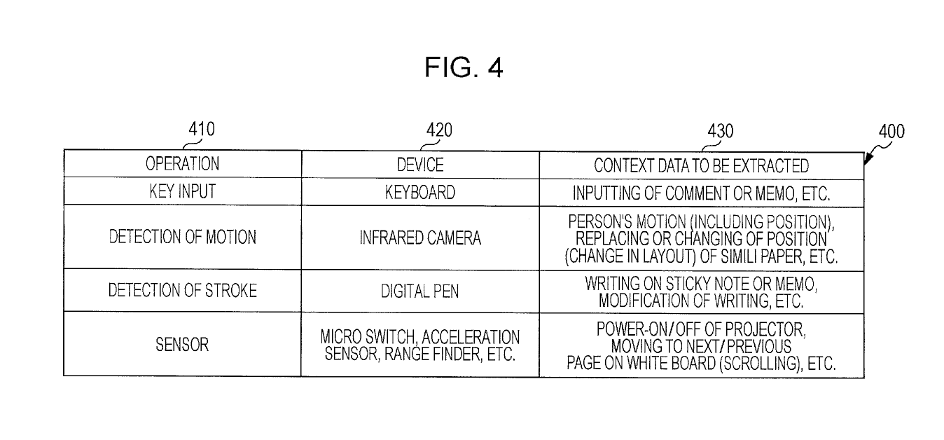

For example, the operators' operations and the device operations which are to be detected are defined in a context-information extraction definition table 400. The detection module 110 stores the context-information extraction definition table 400. The operators' operations and the device operations which are to be detected may be changed by rewriting the data in the context-information extraction definition table 400. FIG. 4 is a diagram for describing an exemplary data structure of the context-information extraction definition table 400. The context-information extraction definition table 400 includes an operation column 410, a device column 420, and a context-data-to-be-extracted column 430. The operation column 410 stores operator's operation data. The device column 420 stores device data. The context-data-to-be-extracted column 430 stores context data detected when an operator operates the device (an operator's operation or a device operation).

Hereinafter, a context encompasses an operator's operation or a device operation in a meeting.

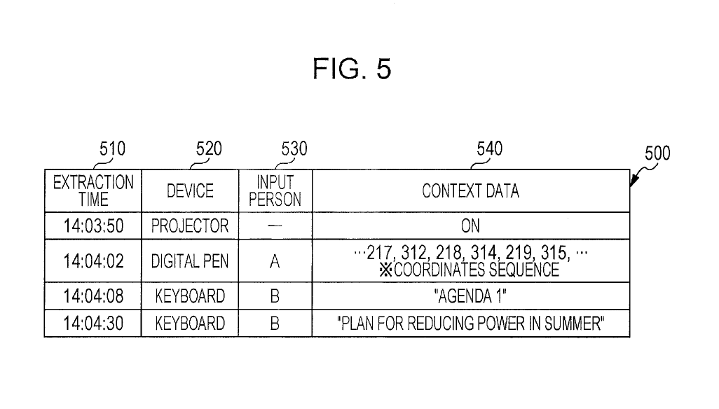

The storage module 120 is connected to the detection module 110 and the information analysis module 130. The storage module 120 stores “information used in a meeting”, and “operators' operations in the meeting” or “device operations in the meeting” which are detected by the detection module 110 as a log (history). For example, the storage module 120 stores a context-information table 500. FIG. 5 is a diagram for describing an exemplary data structure of the context-information table 500. The context-information table 500 includes an extraction time column 510, a device column 520, an input-person column 530, and a context-data column 540. The extraction time column 510 stores a time (represented as year, month, day, hour, minute, second, millisecond, etc., or may be represented as a combination of these) when the detection module 110 performed detection. The device column 520 stores data about a device with which or by which an operation was performed. The input-person column 530 stores identification information of an operator (input person) who did the operation. The context-data column 540 stores context data detected by the detection module 110. For example, when an operator A performed an operation by using a digital pen (device), the detection module 110 detected the operation result (coordinates sequence indicating the path through which the pen point was moved), and stores the operation result with its operation time. The device column 520 or the input-person column 530 may be empty (no devices were used, or operations were performed without operators' operations).

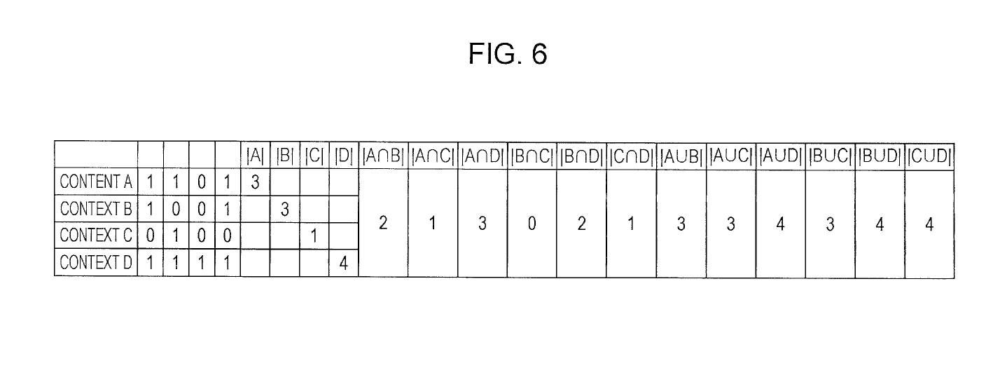

The information analysis module 130 is connected to the storage module 120, the information search module 140, and the information display module 150. The information analysis module 130 analyzes the co-occurrence relationship between information and operators' operations or device operations which were detected by the detection module 110. Examples will be described below with reference to FIGS. 6 to 8.

The information search module 140 is connected to the information analysis module 130 and the information display module 150. The information search module 140 searches the storage module 120 for the information and the operators' operations or the device operations which have been subjected to the analysis by the information analysis module 130, and transmits them to the information display module 150 to display them.

The information display module 150 is connected to the information analysis module 130 and the information search module 140. The information display module 150 displays the relationship between the information and the operators' operations or the device operations which were detected by the detection module 110, on the basis of the analysis result from the information analysis module 130.

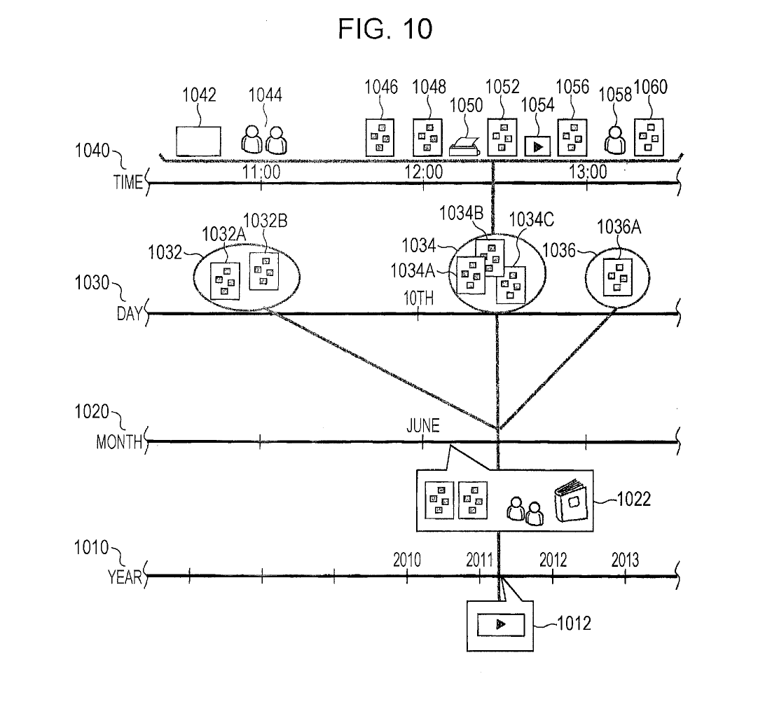

The information display module 150 may display the relationship by using a first axis and a second axis having a time unit larger than that of the first axis. Along the first axis, the information and the operators' operations or the device operations which were detected by the detection module 110 are arranged in time series. Along the second axis, groups constituted by the pieces of information and groups constituted by the operators' operations or groups constituted by the device operations which were detected by the detection module 110 are arranged in time series. An example will be described below with reference to FIG. 10. For example, the first axis is a time axis 1040 or the like, and the second axis is a day axis 1030 or the like which is located at a position lower than the first axis.

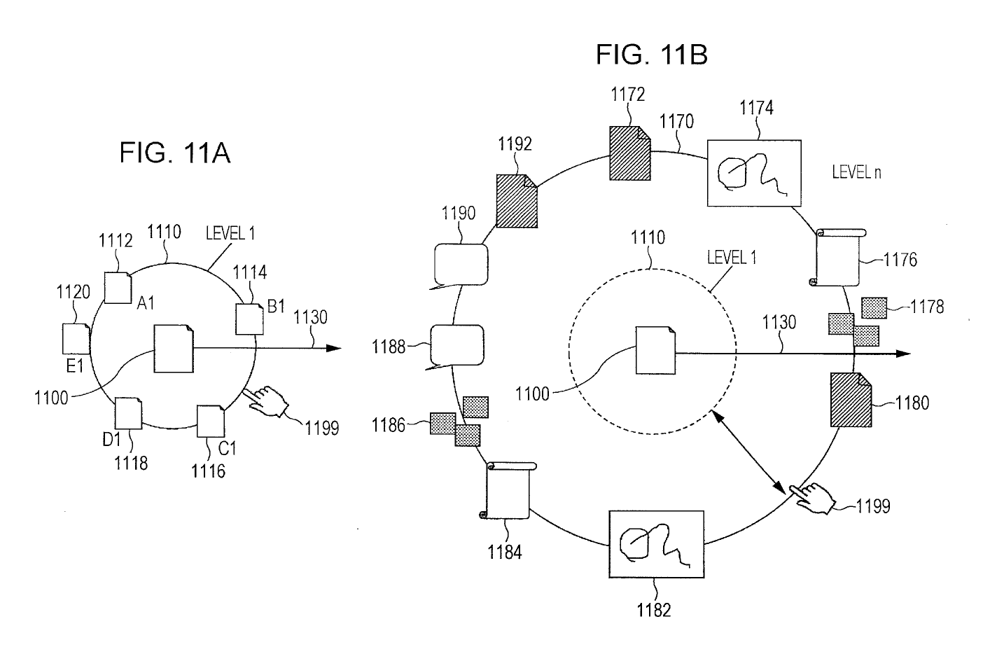

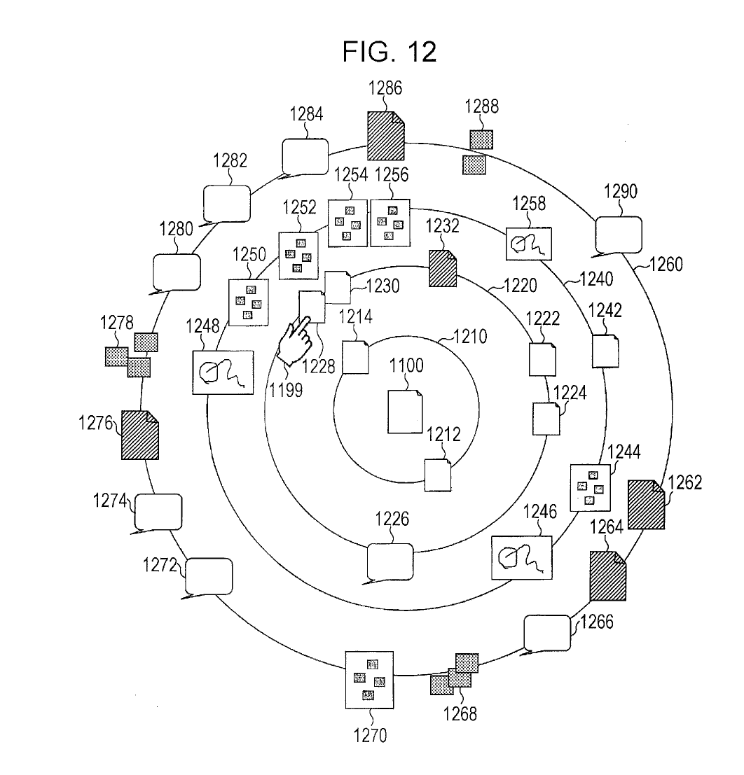

The information display module 150 may dispose a piece of information detected by the detection module 110, at the center, and may dispose the other pieces of information and the operators' operations or the device operations which were detected by the detection module 110, around the piece of information on the basis of the result of the analysis performed by the information analysis module 130 on the piece of information so that the closer the distance obtained from the analysis result from the information analysis module 130 is, the closer the distance from the center is. Examples will be described below with reference to FIGS. 11A to 12. To display the other pieces of information and the like around the piece of information, a circle (loop) is used as illustrated in the examples in FIGS. 11A and 11B. The shape of the loop may be a circle, an ellipse, a regular polygon, or the like. As illustrated in the example in FIG. 12, multiple loops may be used.

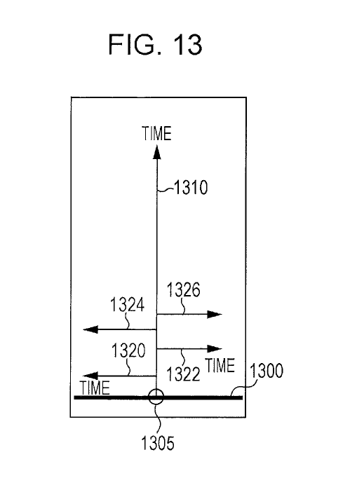

The information display module 150 displays the relationship between the information and the operators' operations or the device operations in a tree format. The information display module 150 may dispose reference information at the base of a tree, and may dispose the other information and the operators' operations or the device operations on the trunk or branches on the basis of the analysis result from the information analysis module 130 so that the longer the time period from the creation of the reference information is, the longer the distance from the position of the reference information is. Examples will be described below with reference to FIGS. 13 to 18B. The reference information is predetermined information, and corresponds to, for example, an outcome document.

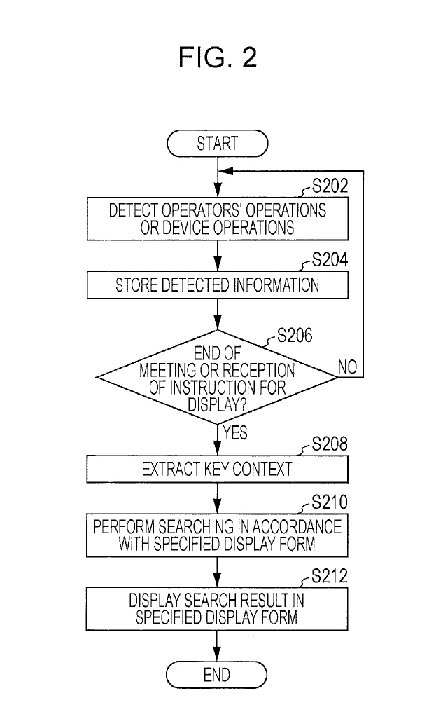

FIG. 2 is a flowchart of an exemplary process according to the present exemplary embodiment.

In step S202, the detection module 110 detects operators' operations or device operations in a meeting.

In step S204, the storage module 120 stores the detected information.

In step S206, the detection module 110 determines whether or not the condition that the meeting ends or that the information display module 150 has received an instruction for display is satisfied. If the determination result is positive, the process proceeds to step S208. Otherwise, the process returns back to step S202. For example, it may be determined that a meeting ends, when power-off for all of the devices used in the meeting is detected.

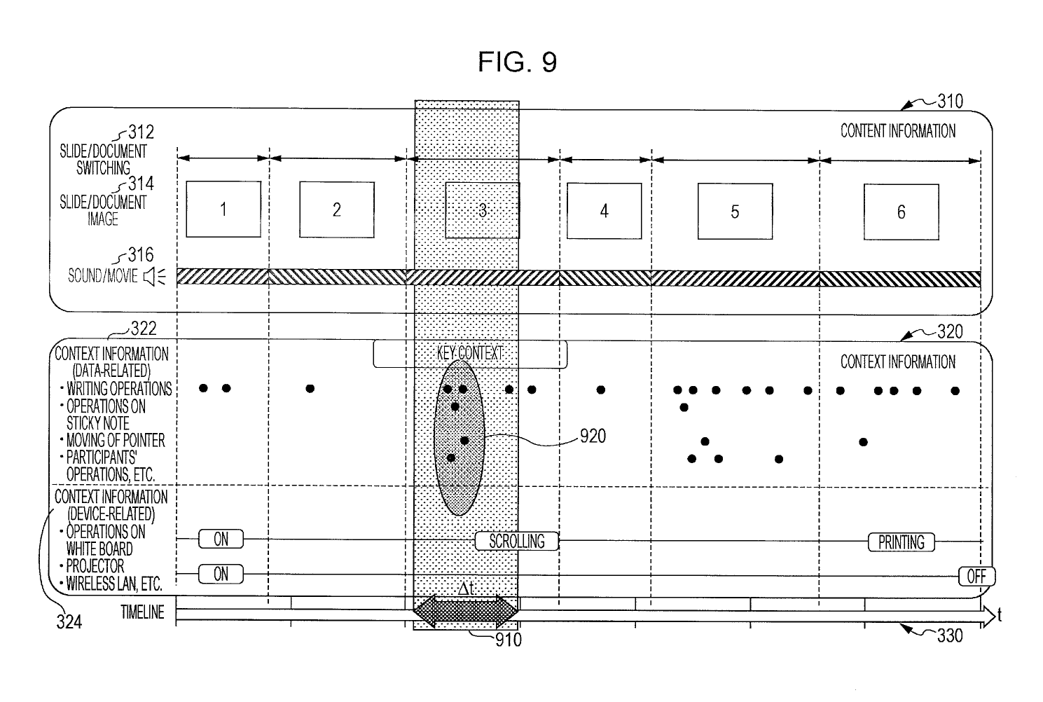

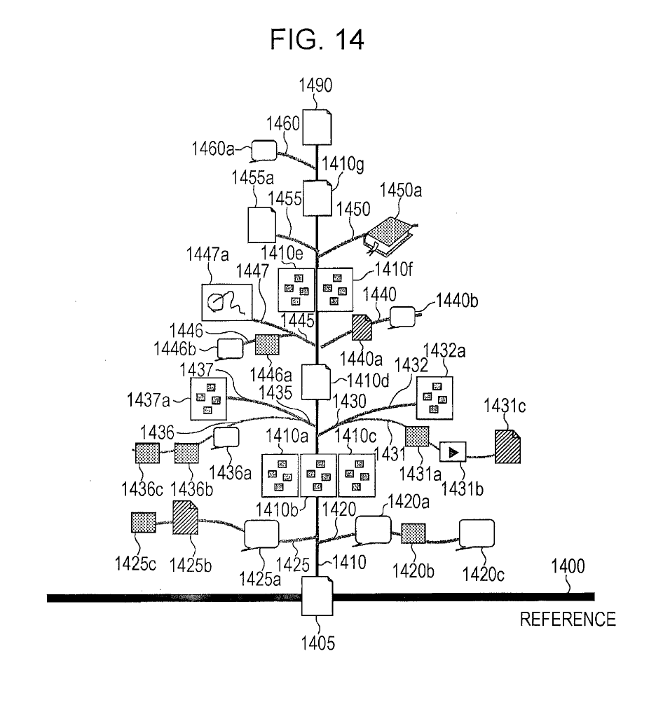

In step S208, the information analysis module 130 extracts a key context. In step S210, the information search module 140 performs searching in accordance with the specified display form. Examples of the display form include those illustrated in FIG. 9, FIG. 10, FIGS. 11A and 11B, and FIG. 14 as described below.

In step S212, the information display module 150 displays the search result in the specified display form.

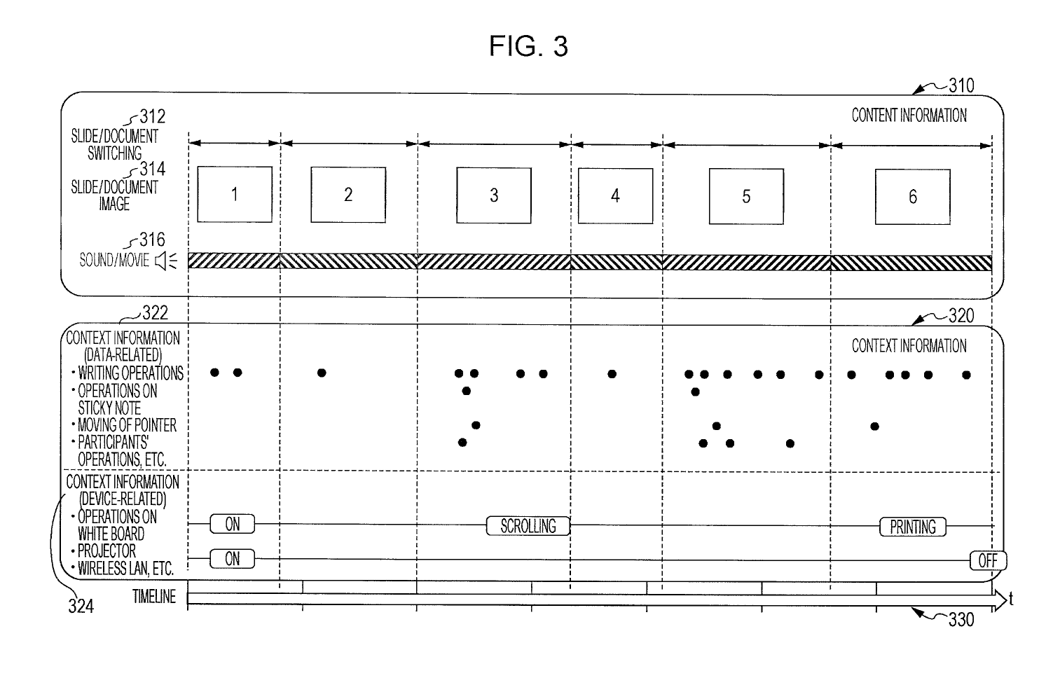

FIG. 3 is a diagram for describing a target to be processed, and an exemplary process according to the present exemplary embodiment. For example, in the case where slides/documents and sounds/movies are mainly used as target information in a meeting, and where a whiteboard, a projector, and a wireless local-area network (LAN) are mainly used as devices, FIG. 3 schematically illustrates the log information in the meeting. The information display module 150 may display data in the storage module 120 in this manner. A content-information display region 310, a context-information display region 320, and a timeline 330 are displayed on the display apparatus such as a liquid-crystal display of the information processing apparatus 100. In the content-information display region 310, a slide/document switching display region 312, a slide/document image display region 314, and a sound/movie display region 316 are displayed. In the slide/document switching display region 312, a time when a slide or a document is switched and a time period for which the slide or the like is displayed are displayed. In the slide/document image display region 314, the slide or a thumbnail image of the document which is displayed for the corresponding period is displayed. In the sound/movie display region 316, the representation indicating that sounds/movies are output for the period is displayed. In the context-information display region 320, a context-information (data-related) display region 322 and a context-information (device-related) display region 324 are displayed. In the context-information (data-related) display region 322, operators' operations performed in the meeting are displayed. For example, dots are plotted at positions corresponding to the times when writing operations, operations on sticky notes, moving of a pointer, and the like were performed. In the context-information (device-related) display region 324, device operations performed in the meeting are displayed. For example, figures are plotted at positions corresponding to the times when power-on of the whiteboard, scrolling, and printing were performed, and at positions corresponding to the times when the projector was turned on and off.

The way of extracting a key context, which is performed by the information analysis module 130, will be described with reference to FIGS. 6 to 8.

To determine the co-occurrence relationship between content and context which are recorded at the same time on the time axis, a known algorithm (group similarity) for determining co-occurrence relationship typically between two terms is extended so that the algorithm may be applied to a polynomial.

A co-occurrence coefficient is a scale representing how often a certain pair of events “co-occurs”. Examples of a typical index include the Jaccard coefficient, the Simpson coefficient, and the cosine distance.

For each of the indexes, the way of measuring co-occurrence of a pair of “X” and “Y” will be described.

The number of occurrences of “X” alone is represented by |X|, and the number of occurrences of “Y” alone is represented by |Y|. The number of occurrences of at least one of “X” and “Y” is represented by |X∪Y|. The number of occurrences of both of “X” and “Y” is represented by |X∩Y|. A co-occurrence frequency means the number of co-occurrences, and is calculated by using |X∩Y|.

(1) Jaccard coefficient: The Jaccard coefficient is a ratio of occurrences of both of “X” and “Y” with respect to occurrences of at least one of “X” and “Y”, and is calculated by using |X∩Y|/|X∪Y|.

(2) Simpson coefficient: In the case of the Jaccard coefficient, when co-occurrences are found in a state in which the number of occurrences of one of “X” and “Y” is large, the denominator is large, resulting in a small Jaccard coefficient.

At that time, the Simpson coefficient in which the “min” operation is used in the denominator is efficient. The calculation is made by using Expression (1) described below.

$$\frac{\vert X ⋂ Y \vert}{min ( \vert X \vert , \vert Y \vert )} \qquad ( 1 )$$

(3) The cosine distance is an index located between the Jaccard coefficient and the Simpson coefficient. The cosine distance is obtained by measuring a distance between vectors, and is calculated by using |X∩Y|/sqrt(|X| |Y|).

Either of the indexes ranges from 0 to 1.

For example, co-occurrence strengths are obtained by using A which represents content and by using B, C, and D, each of which represents a context. The threshold is set to min(|A|, |B|, |C|, |D|). The example in FIG. 6 illustrates a comparison example of coefficients indicating the co-occurrence relationship. Since A=(1, 1, 0, 1) and B=(1, 0, 0, 1), the logical AND of A and B (|A∩B|) is equal to 2, and the logical OR of A and B (|A∪B|) is equal to 3.

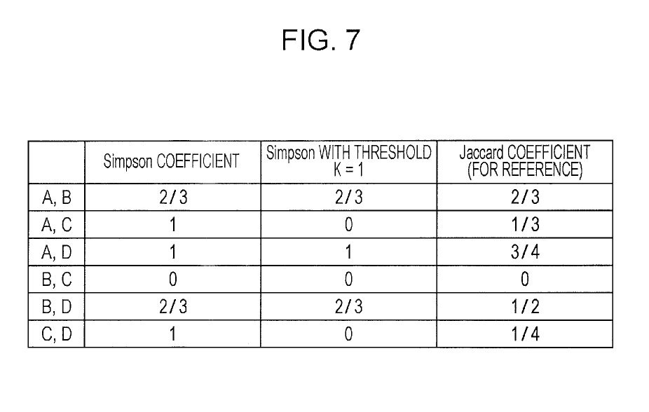

The example in FIG. 7 illustrates a comparison example of coefficients indicating a co-occurrence strength. In this example, the Jaccard coefficient, the Simpson coefficient, and the Simpson coefficient with a threshold are as follows.

(1) Jaccard coefficient: |X∩Y|/|X∪Y|

That is, the Jaccard coefficient indicates a ratio of occurrences of both of “X” and “Y” with respect to occurrences of at least one of “X” and “Y”.

(2) Simpson coefficient: Expression (1) illustrated below is used.

$$\frac{\vert X ⋂ Y \vert}{min ( \vert X \vert , \vert Y \vert )} \qquad ( 1 )$$

That is, the Simpson coefficient is proportional to the correlation relationship between X and Y. In the case where X>>Y or X<<Y, since keywords having a correlation which is not very strong produce a high Simpson coefficient, a threshold is often used to introduce a restriction.

(3) Simpson coefficient with a threshold: Expression (2) illustrated below is used.

$$R ( X , Y ) = \{ \begin{matrix}\frac{\vert X ⋂ Y \vert}{min ( \vert X \vert , \vert Y \vert )} & if \vert X \vert > k and \vert Y \vert > k , \\ 0 & otherwise\end{matrix} \qquad ( 2 )$$

(Data is thinned by using k as a threshold)

For example, as illustrated in FIG. 7, in the case of the Simpson coefficient with a threshold, the key context for the content A is D.

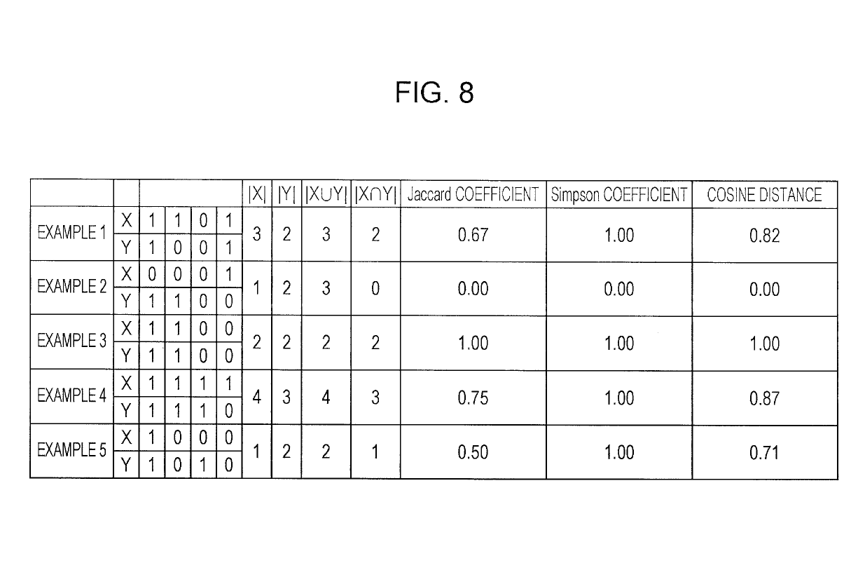

The difference between the co-occurrence coefficients will be described by using the example in FIG. 8.

Expression (1) indicates a coefficient used as an index representing a frequency obtained when a keyword X and a keyword Y appear (co-occur) in the same page or in the same document.

In general, it is presumed that the higher the Simpson coefficient is, the stronger the correlation relationship between the two keywords is. However, the Simpson coefficient has a feature in which, when the number of search results of one of the words to be compared is much smaller than that of the other word, a high value is obtained for the keywords having a correlation which is not very strong (see FIG. 8). Therefore, the aspect in which use of only the Simpson coefficient produces an insufficient result is often complemented by setting a threshold to introduce a restriction on the Simpson coefficient, or by actually viewing the obtained experiment results with person's eyes to check if the keywords have a strong correlation.

In the present exemplary embodiment, the Simpson coefficient with a threshold is used to obtain the co-occurrence relationship for multiple pieces of information, but other coefficients may be used.

FIG. 9 is a diagram for describing a target to be processed, and an exemplary process according to the present exemplary embodiment. FIG. 9 illustrates a result obtained through the process performed by the information analysis module 130, in addition to the above-described example in FIG. 3. In this example, when an operator specifies the slide/document “3” in the slide/document image display region 314 in a specified period 910 (time axis), the co-occurrence strength between the information (slide/document “3”) and contexts which are recorded in a period around the specified time (in the specified period 910, or in Δt) is calculated. The information analysis module 130 records contexts having a strong co-occurrence (key context group 920 in FIG. 9), as a key context. The information display module 150 displays the process result obtained by the information analysis module 130, as illustrated in the example of FIG. 9.

FIG. 10 is a diagram for describing an exemplary process according to the present exemplary embodiment (the information display module 150). Among the ways of displaying contexts, one based on timelines is illustrated.

In FIG. 10, multiple scales which are different to each other (an year axis 1010, a month axis 1020, a day axis 1030, and a time axis 1040) are displayed in the horizontal or vertical direction. For example, the time axis 1040 and the day axis 1030 have different time units, and the day axis 1030 has a time unit larger than that of the time axis 1040. On each of the axes, figures representing content and contexts are arranged in time series in accordance with the date and time when the content and the contexts are produced. On the time axis 1040, figures representing the content and the contexts themselves are arranged. In contrast, on the day axis 1030, figures representing a group of content and contexts are arranged. A figure representing a group of content and contexts may be one representing the content included in the group (in FIG. 10, a board 1034A, a board 1034B, and a board 1034C), or a figure representing a key context may be used as a typical figure.

When an operator performs a scroll operation in which the scale on a specified axis is scrolled in the horizontal or vertical direction, the other scales are scrolled in accordance with the scrolling.

When a time interval and content are specified as a search condition, the information search module 140 searches for a key context satisfying the search condition, and the information display module 150 displays it.

FIGS. 11A and 11B are diagrams for describing an exemplary process according to the present exemplary embodiment (the information display module 150). Among the ways of displaying contexts, one using loops is illustrated.

As illustrated in the example in FIG. 11A, an outcome document 1100 which is information detected by the detection module 110 is disposed at the center. For example, the final outcome document 1100 in a series of meetings may be selected, or content selected by an operator may be used as the outcome document 1100. On the basis of the result of analysis performed on the outcome document 1100 by the information analysis module 130, other content (such as a document 1112) or contexts are disposed around the outcome document 1100 (on a level-1 loop 1110) so that the closer the distance indicated by the analysis result obtained by the information analysis module 130 is, the closer the distance from the outcome document 1100 is. On the level-1 loop 1110, the document 1112, a document 1114, a document 1116, a document 1118, and a document 1120 are disposed. A coordinate axis 1130 indicates that the longer the distance from the center of the level-1 loop 1110 is, the finer the granularity of context is. That is, more pieces of context information are displayed. For example, an operator moves an icon 1199 for giving an instruction, and specifies a distance from the center (distance on the coordinate axis 1130), whereby content or contexts are extracted in accordance with the distance, and are displayed.

The example in FIG. 11B illustrates a case in which the distance from the outcome document 1100 is larger than that in the example in FIG. 11A. On a level-n loop 1170, a context 1172, a context 1174, a context 1176, a context 1178, a context 1180, a context 1182, a context 1184, a context 1186, a context 1188, a context 1190, and a context 1192 are disposed. That is, not only content but also many contexts are included.

In this example, the granularity is changed in accordance with the level of contexts to be grasped, with respect to an outcome obtained at a certain time point, and the contexts are displayed. The degree of the granularity is proportional to the distance from the outcome. Use of a loop causes the displayed items to be viewed at a glance, achieving deeper understanding of the connections among contexts.

FIG. 12 is a diagram for describing an exemplary process according to the present exemplary embodiment (the information display module 150). FIG. 12 illustrates an example using multiple loops. On a level-1 loop 1210, a context 1212 and a context 1214 are disposed.

On a level-2 loop 1220, a context 1222, a context 1224, a context 1226, a context 1228, a context 1230, and a context 1232 are disposed. On a level-3 loop 1240, a context 1242, a context 1244, a context 1246, a context 1248, a context 1250, a context 1252, a context 1254, a context 1256, and a context 1258 are disposed. On a level-4 loop 1260, a context 1262, a context 1264, a context 1266, a context 1268, a context 1270, a context 1272, a context 1274, a context 1276, a context 1278, a context 1280, a context 1282, a context 1284, a context 1286, a context 1288, and a context 1290 are disposed.

By specifying multiple positions from the outcome document 1100 which is an outcome, multiple loops (the level-1 loop 1210, the level-2 loop 1220, the level-3 loop 1240, and the level-4 loop 1260) are generated, achieving understanding of a flow of contexts.

After the outmost loop is specified, loops at intermediate positions may be generated. For example, loops may be generated at predetermined intervals, or a predetermined number of loops may be generated. By providing loops at intermediate positions, contexts may be closely viewed.

When items (figures representing content and contexts) to be displayed on a loop fails to be displayed because they are too many, display of some of pieces of context items may be skipped.

FIG. 13 is a diagram for describing an exemplary process according to the present exemplary embodiment (the information display module 150). FIG. 13 illustrates the example in which the relationship between content and contexts is represented in a tree form. A reference outcome 1305 which serves as a reference is disposed at the tree base. On the basis of the analysis result from the information analysis module 130, figures representing content and contexts are disposed on a trunk 1310 or branches 1320 to 1326 so that the longer the time period from the creation of the reference outcome 1305 is, the longer the distance from the tree base at which the reference outcome 1305 is located is. Examples of content which serves as a reference include a document used at the first stage in the meeting.

On the trunk 1310, figures representing outcomes (including intermediate products) in the activity (meeting) are displayed in time series. On the branches 1320 to 1326, figures representing content or contexts in other meetings or the like whose theme is derived from an intermediate product are displayed. Examples are illustrated in FIGS. 14 to 18B.

FIG. 14 is a diagram for describing an exemplary process according to the present exemplary embodiment (the information display module 150). A reference outcome 1405 which is an outcome obtained at a certain time point is disposed as a reference point. Then, content and contexts produced afterwards are displayed.

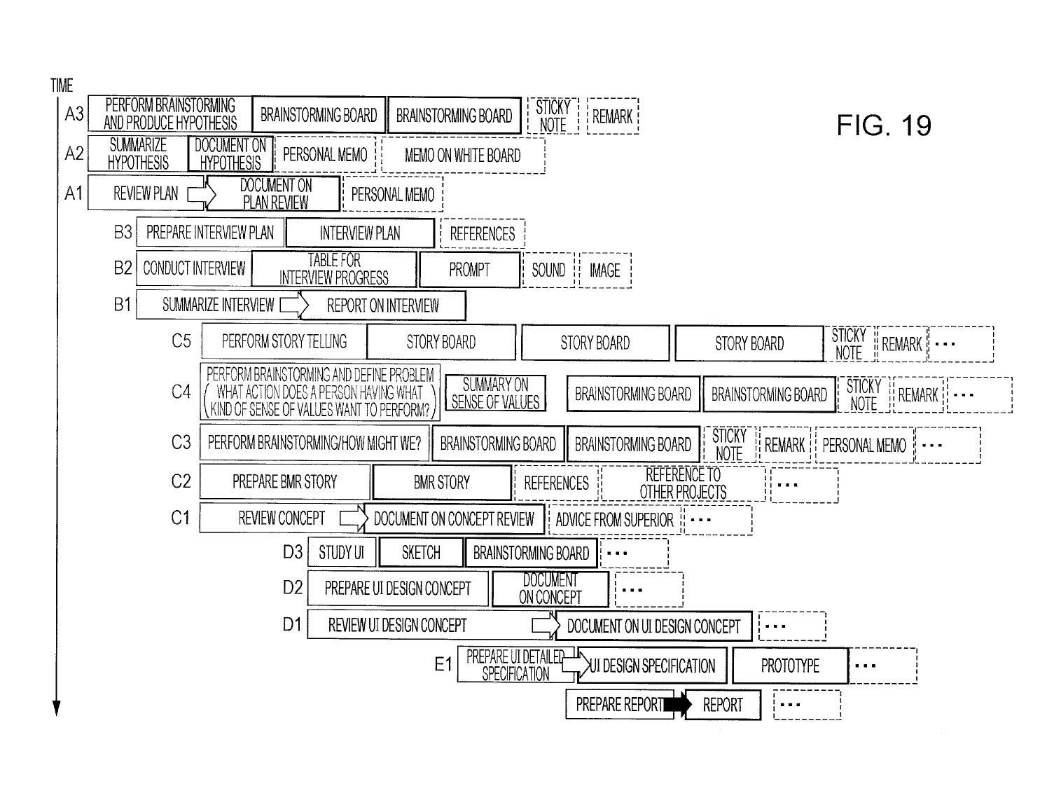

The vertical axis of this tree corresponds to a trunk 1410 on which intermediate products (pieces of content in A1, B1, C1, D1, and E1 illustrated in the example in FIG. 19) in the entire activity are disposed in time series. This example illustrates the activity illustrated in FIG. 19 in a tree form. In the example in FIG. 19, the vertical axis represents time, and on the horizontal axis, content derived from the first outcome (content disposed at the leftmost position), and contexts arising in a process of producing the derived content are arranged. A rectangle drawn with a solid line represents a process, and a rectangle drawn with a bold solid line represents content. A rectangle drawn with a dotted line represents context information. A white arrow indicates that an outcome is produced at that time point, and a black arrow indicates that the final outcome is produced. For example, in “A1”, the outcome from the process “REVIEW PLAN” is the content “DOCUMENT ON PLAN REVIEW”, and the final outcome in the entire activity is the content “REPORT”.

The horizontal axis is represented by a “branch” (such as a branch 1420 or a branch 1425). A group of activities in the entire activity is differentiated, and produces a branch. For example, a branch 1430 is divided into a branch 1431 and a branch 1432. A branch 1435 is divided into a branch 1436 and a branch 1437. A branch 1445 is divided into a branch 1446 and a branch 1447. On the trunk and branches, figures representing content and contexts are disposed in time series. A branch corresponds to the horizontal axis in the example in FIG. 19.

Thus, displaying of the entire tree facilitates grasping of the amount of the activity.

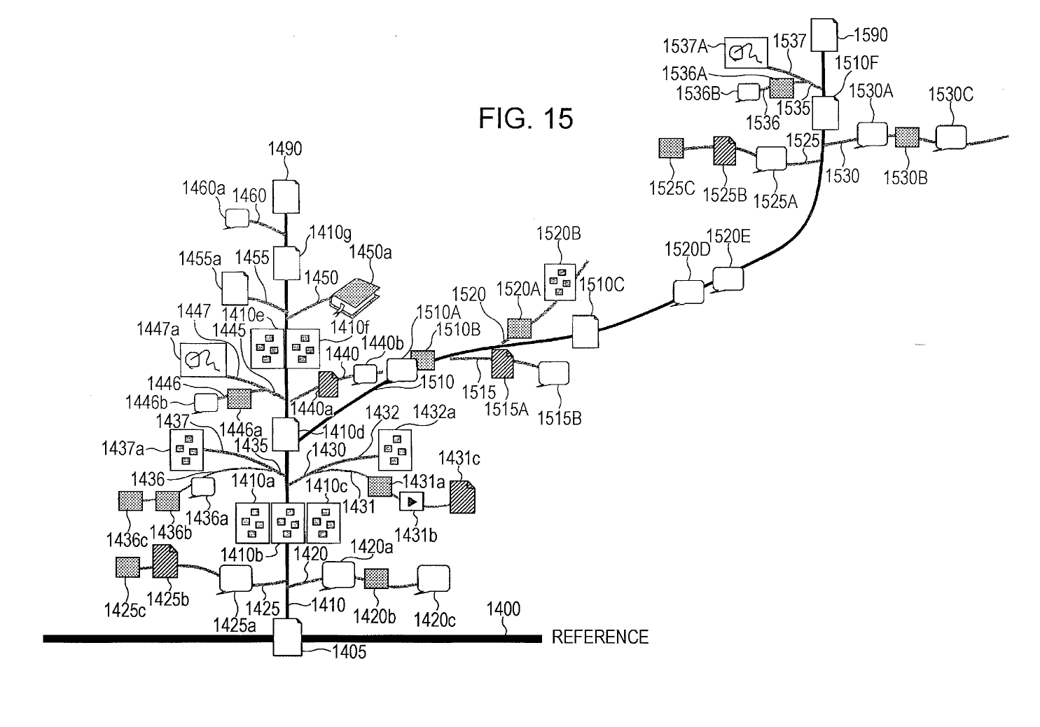

FIG. 15 is a diagram for describing an exemplary process according to the present exemplary embodiment (the information display module 150). An example is illustrated in which, as the activity progresses with time, the shape of the tree gradually changes. A branch 1510 is divided into a branch 1515, a branch 1520, a branch 1525, a branch 1530, and a branch 1535. The branch 1535 is divided into a branch 1536 and a branch 1537. The activity further progresses from content or a context on a branch. When the branch is connected to a tree representing another activity, the branch is displayed as a trunk. FIG. 15 illustrates a state in which a document 1410d is introduced to another project (meeting), and in which a final outcome document 1590 is produced in the project. That is, two projects produce respective outcomes (an outcome document 1490 and the outcome document 1590).

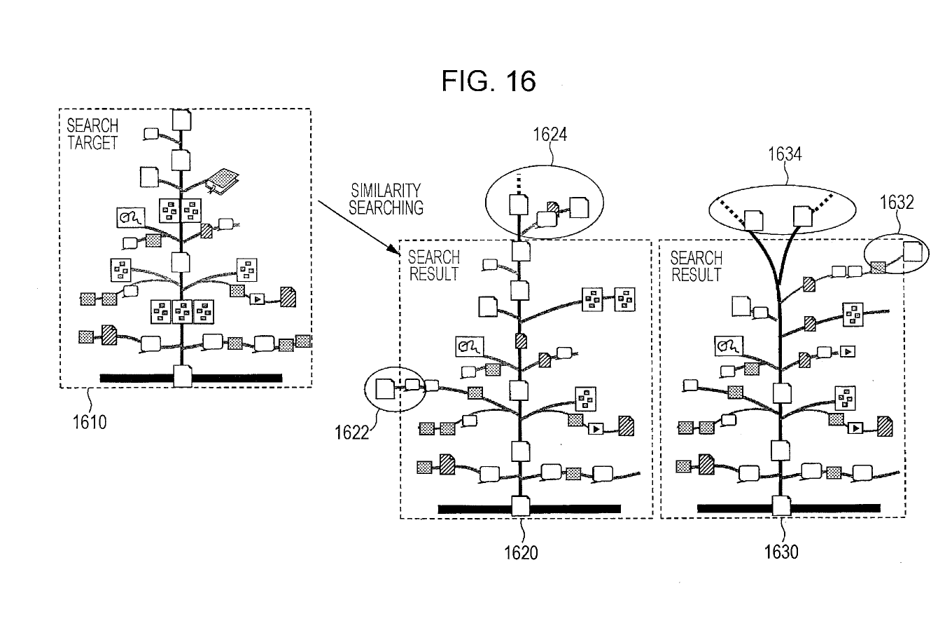

FIG. 16 is a diagram for describing an exemplary process according to the present exemplary embodiment (the information display module 150). This example illustrates a case in which a tree having a similar shape is obtained through similarity searching of trees for other meetings in the middle of the activity (for example, when the discussion reaches a dead end). The information search module 140 performs this search. Similarity searching may be performed in such a manner that a tree in which the number of branches, the distance between branches, the number of pieces of content and contexts, and the like fall within a predetermined range is regarded as a similar tree. For example, a tree similar to the leftmost tree (search target 1610) in FIG. 16 is searched for, and two trees (search results 1620 and 1630) are displayed as the search result.

The information display module 150 presents different parts in the search result tree (in the case of the search result 1620, a difference 1622 and a difference 1624; and in the case of the search result 1630, a difference 1632 and a difference 1634) The participants in the meeting view the different content and the different contexts in the search result to get some information, and take an action. For example, the search result helps break the dead end of discussion. Especially, a top portion of a trunk, the entire branch, or a tip portion of a branch may be extracted as a different part.

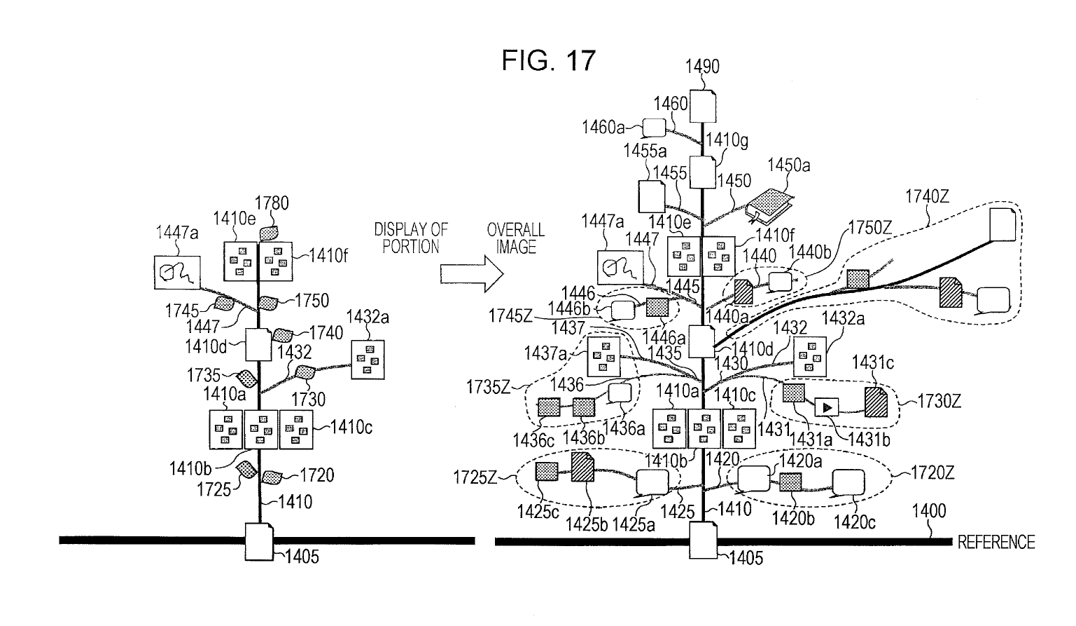

FIG. 17 is a diagram for describing an exemplary process according to the present exemplary embodiment (the information display module 150). The example illustrates a case in which the number of pieces of content or contexts displayed on a branch is more than a predetermined value. A figure indicating that a branch is not displayed (for example, a leaf bud 1720) is displayed. When an operator specifies the leaf bud 1720, the branch extends and the pieces of content or the contexts which have not been displayed are displayed. In the example in FIG. 17, a figure having a leaf bud shape is displayed instead of a branch having two or more pieces of content or two or more contexts. For example, the leaf bud 1720 indicates that the content or the contexts on the branch 1420 (in an original leaf bud 1720Z) are not displayed. When an operator specifies the leaf bud 1720, a remark 1420a, a sticky note 1420b, and a remark 1420c, instead of which the leaf bud 1720 has been displayed, are displayed.

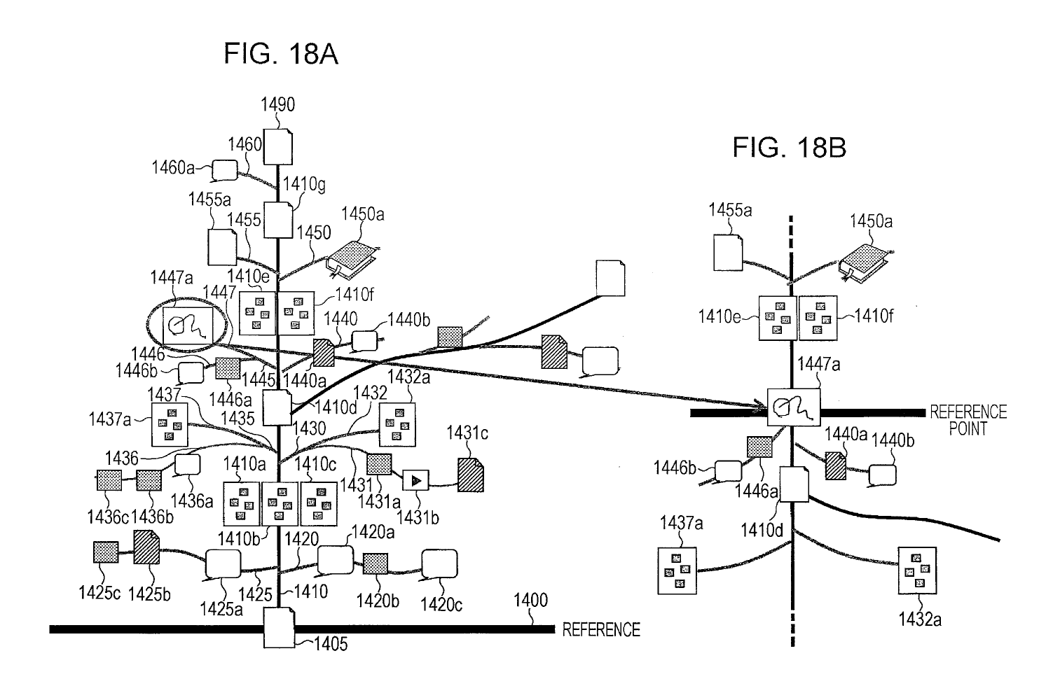

FIGS. 18A and 18B are diagrams for describing an exemplary process according to the present exemplary embodiment (the information display module 150). The example illustrates a case in which the content specified as the reference point is changed. Thus, the shape of the tree is changed. Sometimes, the root may be displayed.

In the case of the example in FIG. 18A, when an operator selects a board 1447a in the tree as the reference point, as illustrated in the example in FIG. 18B, a reference 1400 is moved to the position of the board 1447a, and the trunk and branches derived from the reference point are displayed. Thus, the content or the contexts produced before the creation of the selected board 1447a are disposed as the root at positions lower than the reference 1400.

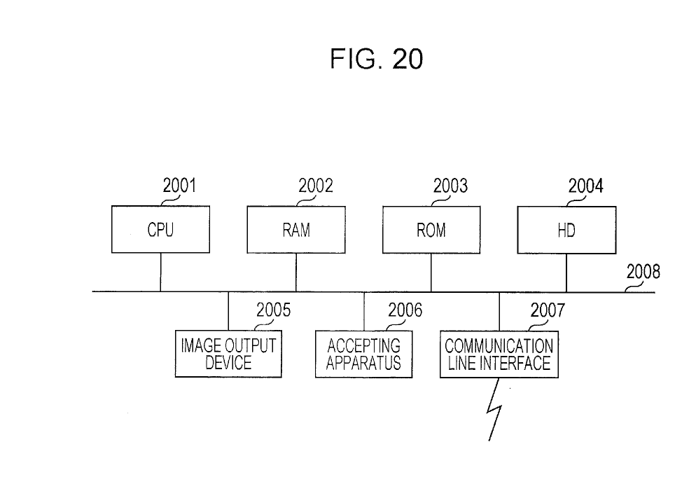

As illustrated in FIG. 20, the hardware configuration of a computer in which programs achieving the exemplary embodiment are executed constitutes a typical computer, and specifically, constitutes a computer or the like which may serve as a personal computer or a server. That is, the exemplary configuration employs a CPU 2001 as a processor (arithmetic logical unit), and employs a RAM 2002, a read-only memory (ROM) 2003, and an HD 2004 as storage devices. For example, a hard disk may be used as the HD 2004. The computer includes the following components: the CPU 2001 which executes programs, such as the detection module 110, the information analysis module 130, the information search module 140, the information display module 150, and the like; the RAM 2002 which stores the programs and data; the ROM 2003 which stores programs and the like for starting the computer; the HD 2004 which is an auxiliary memory (which may be a flash memory or the like); an accepting apparatus 2006 which accepts data on the basis of an operation performed by a user on a keyboard, a mouse, a touch panel, or the like; an image output device 2005 such as a cathode-ray tube (CRT) or a liquid crystal display; a communication line interface 2007 for establishing connection to a communication network, such as a network interface card; and a bus 2008 for connecting the above-described components to each other and for receiving/transmitting data. Computers having this configuration may be connected to one another via a network.

In the case where the above-described exemplary embodiment is achieved by using computer programs, computer programs which are software are read into a system having the hardware configuration, and the software and the hardware resources cooperate with each other to achieve the above-described exemplary embodiment.

The hardware configuration in FIG. 20 is merely one exemplary configuration. The exemplary embodiment is not limited to the configuration in FIG. 20, and may have any configuration as long as the modules described in the exemplary embodiment may be executed. For example, some modules may be constituted by dedicated hardware, such as an application-specific integrated circuit (ASIC), and some modules which are installed in an external system may be connected through a communication line. In addition, systems having the configuration illustrated in FIG. 20 may be connected to one another through communication lines and may cooperate with one another. In particular, the hardware configuration may be installed in home information equipment, a copier, a fax, a scanner, a printer, a multi-function device (image processing device having two or more functions of scanning, printing, copying, faxing, and the like) as well as a personal computer.

The programs described above may be provided through a recording medium which stores the programs, or may be provided through a communication unit. In these cases, for example, the programs described above may be interpreted as an invention of “a computer-readable recording medium that stores programs”.

The term “a computer-readable recording medium that stores programs” refers to a computer-readable recording medium that stores programs and that is used for, for example, the installation and execution of the programs and the distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray® Disk, a magneto-optical disk (MO), a flexible disk (FD), a magnetic tape, a hard disk, a ROM, an electrically erasable programmable ROM (EEPROM®), a flash memory, a RAM, and a secure digital (SD) memory card.

The above-described programs or some of them may be stored and distributed by recording them on the recording medium. In addition, the programs may be transmitted through communication, for example, by using a transmission medium of, for example, a wired network which is used for a local area network (LAN), a metropolitan area network (MAN), a wide area network (WAN), the Internet, an intranet, an extranet, and the like, a wireless communication network, or a combination of these. Instead, the programs may be carried on carrier waves.

The above-described programs may be included in other programs, or may be recorded on a recording medium along with other programs. Instead, the programs may be recorded on multiple recording media by dividing the programs. The programs may be recorded in any format, such as compression or encryption, as long as it is possible to restore the programs.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detection unit that detects pieces of information used in a meeting and operator's operations performed in the meeting or device operations performed in the meeting;
an analysis unit that analyzes a co-occurrence relationship between the pieces of information and the operator's operations or the device operations which are detected by the detection unit; and
a display unit that displays the relationship between the pieces of information and the operator's operations or the device operations which are detected by the detection unit, on the basis of a result of the analysis performed by the analysis unit.

2. The information processing apparatus according to claim 1,
wherein the display unit produces a display by using
a first axis along which the pieces of information and the operator's operations or the device operations which are detected by the detection unit are arranged in time series, and
a second axis which has a time unit longer than the time unit of the first axis, and along which at least one group constituted by the pieces of information and at least one group constituted by the operator's operations or at least one group constituted by the device operations are arranged in time series, the pieces of information and the operator's operations or the device operations being detected by the detection unit.

3. The information processing apparatus according to claim 1,
wherein the display unit disposes a piece of information detected by the detection unit, at the center, and disposes the other pieces of information and the operator's operations or the device operations which are detected by the detection unit, around the piece of information on the basis of a result of the analysis performed by the analysis unit on the piece of information, and produces a display in which the closer a distance indicated by the result of the analysis performed by the analysis unit is, the smaller a distance from the center is.

4. The information processing apparatus according to claim 1,
wherein the display unit displays the relationship between the pieces of information and the operator's operations or the device operations, in a tree form, disposes a piece of information which serves as a reference, at a tree base, and disposes the other pieces of information and the operator's operations or the device operations on at least one trunk or at least one branch of the tree on the basis of a result of the analysis performed by the analysis unit, in such a manner that the longer a time period from creation of the piece of information which serves as a reference is, the longer a distance from a position of the reference is.

5. A non-transitory computer readable medium storing a program causing a computer to execute a process for information processing, the process comprising:
detecting pieces of information used in a meeting and operator's operations performed in the meeting or device operations performed in the meeting;
analyzing a co-occurrence relationship between the pieces of information and the operator's operations or the device operations which are detected; and
displaying the relationship between the pieces of information and the operator's operations or the device operations which are detected, on the basis of a result of the analysis.

6. An information processing method comprising:
detecting pieces of information used in a meeting and operator's operations performed in the meeting or device operations performed in the meeting;
analyzing a co-occurrence relationship between the pieces of information and the operator's operations or the device operations which are detected; and
displaying the relationship between the pieces of information and the operator's operations or the device operations which are detected, on the basis of a result of the analysis.
